(19) United States
(12) Patent Application Publication
(10) Pub. No.: US 2026/0344792 A1
(43) Pub. Date: Nov. 5, 2026

(54) AEROSOL GENERATING APPARATUS

(71) Applicant: Imperial Tobacco Limited, Bristol (GB)

(72) Inventors: Lik Hon, Amsterdam (NL); Zhuoran Li, Beijing (CN); Fucheng Yu, Beijing (CN); David Thomas, Bristol (GB); Robert Wallace, Bristol (GB); Phillip Taylor, Bristol (GB); Jan Hyla, Bristol (GB)

(21) Appl. No.: 19/487,387

(22) PCT Filed: May 26, 2023
(86) PCT No.: PCT/CN2023/096467

§ 371 Date: Nov. 24, 2025

(51) Int. Cl. A24F 40/57; A24F 40/10; A24F 40/51; H05B 1/02; H05B 3/04

(52) U.S. Cl. CPC A24F 40/57; A24F 40/10; A24F 40/51; H05B 1/02; H05B 3/04

(57) ABSTRACT

An aerosol generating apparatus 1 comprising a device body 10 and a consumable 30 is disclosed. The device body 10 comprises a sensor 44 for detecting infrared (IR) radiation. The consumable 30 comprises a heating system 34 operable to generate an aerosol from a liquid aerosol precursor 6, the heating system 34 including a heater 341. An optical path is formed between the heating system 34 and the sensor 44. The consumable 10 comprises an IR transmissive window 42 located along the optical path and through which IR radiation can radiate from the heating system 34 to the sensor 44. Also disclosed is a method of operating the aerosol generating apparatus 1.

### FIELD

The present disclosure relates to an aerosol generating apparatus.

### BACKGROUND

A typical aerosol generating apparatus may comprise a power supply, an aerosol generating unit that is driven by the power supply, an aerosol precursor, which in use is aerosolised by the aerosol generating unit to generate an aerosol, and a delivery system for delivery of the aerosol to a user.

A drawback with known aerosol generating apparatuses is that operating the aerosol generating unit in the absence of an aerosol precursor may cause overheating of and/or damage to the aerosol generating unit. In spite of the effort already invested in the development of aerosol generating apparatuses/systems further improvements are desirable.

### SUMMARY

The present disclosure provides an aerosol generating apparatus comprising a device body and a consumable. The device body comprises a sensor for detecting infrared (IR) radiation. The consumable comprises a heating system operable to generate an aerosol from a liquid aerosol precursor, the heating system including a heater. An optical path is formed between the heating system and the sensor, the consumable comprises an IR transmissive window located along the optical path and through which IR radiation can radiate from the heating system to the sensor.

Sensing the IR emission of the heating system via a sensor located in a device body may enable an indirect measurement of the operating condition of the heating system. For example, this may allow detection or determination of an operation of the heating system under a low aerosol precursor condition, which may be an undesirable operating condition. Detection of such an operating condition may therefore enable the apparatus to limit or prevent operation under this condition. Locating the sensor in the device body rather than in the consumable is advantageous in that it reduces an assembly cost for the consumable compared to a situation wherein the consumable includes a sensor such as an IR sensor for detecting or determining an operating condition of the heating system such as a low aerosol precursor operating condition of the heating system.

In some examples, the heating system may further comprise a fluid transfer element or wick. The wick may be partially located in an aerosol precursor reservoir or aerosol precursor tank of the consumable, and may be arranged to transfer aerosol precursor from the reservoir to the heater. The wick may be formed of a porous material such as a porous ceramic material. In some examples, the heater may be a heater coil that is wrapped around the wick. In other examples, the heater may be formed on a surface of the wick. For example, the heater may be a heater track formed on a surface, such as a planar surface, of the wick.

In some examples, the IR transmissive window may be at least one of an impermeable, sealed, hermetically sealed, fluid-tight, air-tight IR transmission opening. The IR transmissive window may comprise a transparent material or IR transparent material.

Providing the consumable with a window that is formed in this way (e.g. one that does not create a fluid or air permeable opening in the consumable) may allow measurement of the IR radiation from the heating system without creating a port or opening in the consumable that may otherwise disrupt air flow within the consumable and/or enable leakage of aerosol precursor from the consumable.

In some examples, the IR transmissive window may comprise a lens for focussing IR radiation from the heating system on to the sensor.

A lens configured in this way may enable a higher proportion of IR radiation from the heating system to be directed on to the sensor for improved detection of the IR radiation. A lens configured in this way may also reduce a level of background noise received by the sensor by more selectively directing IR radiation from a particular region or point (e.g. the focal point of the lens) to the sensor. This may therefore provide increased sensitivity and increased signal-to-noise ratio for the IR detection.

In some examples, a focal point of the lens may be located on a surface of the heater.

Configuring the lens to have a focal point located at or on a surface of the heater may further enable improved transmission of the IR radiation from the heater to the sensor.

In some examples, a surface of the window facing towards the heating system may be shaped to displace a liquid aerosol precursor incident on the surface of the window from the optical path. For example, the surface of the window may be convex.

In this way, condensation of aerosol precursor and/or leaked aerosol precursor that impinges on the window may be better displaced to reduce distortion or blocking of IR transmission from the heating system to the sensor.

In some examples, the IR transmissive window may comprise an optical filter. The window may thus be configured as a filter for the IR radiation.

In other words, the IR transmissive window may reduce or restrict the passage of certain wavelengths of IR or other radiation through the IR transmissive window. In this way, the IR transmissive window may preferentially allow certain wavelengths of interest to pass along the optical pathway and through the IR transmissive window from the heating system to the sensor. This can enable increased sensitivity and increased signal-to-noise ratio for the IR detection by removing or restricting undesired wavelengths such as visible light from passing to the sensor through the IR transmissive window.

In some examples, the IR sensor may be configured to detect an IR spectrum of the heating system. A detected spectrum may include, for example, measurements of IR emission at a plurality of emission wavelengths. These may be equally spaced wavelengths across a range of wavelengths, or may be a particular set of selected wavelengths. The wavelengths may be selected based on characteristics of the IR emission spectrum of the heating system. For example, wavelengths may be selected that correspond to expected peaks or troughs in the IR emission spectrum, or that correspond to wavelengths that are expected to have high variance according to changes in the condition of the heating system.

Detection of an IR spectrum in this way may allow characteristics of the IR emission from the heating system to be detected or determined, which may provide an improved measurement data set compared to measurements taken at a single wavelength.

In some examples, the apparatus may be configured to determine a temperature and/or a rate of increase of temperature and/or a rate of decrease of temperature of the heating system based on the detected IR spectrum.

The temperature of the heating system can indicate the operating condition of the heating system.

For example, where the peak temperature of the heating system during a heating cycle is measured, an increased peak temperature may be indicative of a reduced aerosol precursor supply. Similarly, where the rate of change of temperature of the heating system during a heating cycle is measured, an increased rate of heating and/or a reduced rate of cooling may be indicative of a reduced aerosol precursor supply. Measurement of these characteristics based on the IR emission spectrum may therefore enable a reduced aerosol precursor condition to be detected. Where the aerosol precursor is a liquid, this may also be referred to as low liquid level detection.

In some examples, the aerosol generating apparatus may further comprise control means for controlling operation of the heater. The control means may be operable to interrupt operation of the heater when the determined temperature of the heating system rises above a threshold temperature value and/or when the rate of increase of temperature is higher than a temperature increase rate threshold value and/or when the rate of decrease of temperature is lower than a temperature decrease rate threshold value.

Since these temperature profiles which may be detectable from the IR emission spectrum may indicate that a supply of aerosol precursor to the heating system is reduced, interrupting the operation of the heater based on one or more of these characteristics being detected may enable the device to prevent or limit operation of the heating system under a low aerosol precursor condition.

In some examples, the aerosol generating apparatus may comprise control means for controlling operation of the heater and the control means may be operable to interrupt operation of the heater when the detected IR spectrum of the heating system is indicative of the heating system operating in an absence of liquid aerosol precursor.

Aside from determining a temperature of the heating system based detected IR spectrum, the IR spectrum may contain further characteristics that may indicate a low aerosol precursor condition. For example, particular wavelengths of the IR emission may be absorbed by the aerosol precursor when present, meaning that an increased detected level of IR emission at these wavelengths may indicate a low aerosol precursor condition.

In some examples, the apparatus may configured to determine a presence of the aerosol generated by the heating system from the liquid aerosol precursor based on the detected IR spectrum. For example, generated aerosol may be detectable as an additional source of IR radiation (such as a source of IR radiation that is displaced from or separate from the heating system, or a source of IR radiation that has a separate or distinct IR spectrum). Generated aerosol may be detectable via an effect of scattering of the IR emission from the heating system by droplets of the aerosol.

This can enable a more direct determination of whether or not the heating system is generating an aerosol, and may be in addition to and/or as an alternative to measuring the temperature and/or characteristics of the heating system itself.

In some examples. the aerosol generating apparatus may comprise control means for controlling operation of the heater and the control means may be operable to interrupt operation of the heater when the heater is heated and when the detected IR spectrum indicative of the absence of the aerosol generated by the heating system.

An operating condition wherein the heating system or heater is heated and wherein no detectable aerosol is produced is likely to indicate that the apparatus is operating under a low aerosol precursor condition. Therefore, interrupting the operation of the heater based on a lack of detected aerosol may enable the apparatus to prevent or limit operation of the heating system under a low aerosol precursor condition.

The present disclosure may provide a method of operating an aerosol generating apparatus, which may implement any one or more features disclosed herein. The method may comprise the steps of operating the heating system; detecting IR radiation from the heating system using the IR sensor to generate a detected IR spectrum; and determining whether the detected IR spectrum is indicative of the heating system operating in an absence of liquid aerosol precursor.

This operating method provides a method whereby the apparatus is operable to detect that the apparatus is operating (or likely to be operating) under a low aerosol precursor condition.

In some examples, the method may further comprise a step of interrupting operation of the heating system when it is determined that the detected IR spectrum is indicative of the heating system operating in an absence of liquid aerosol precursor.

This can provide an operating method that can prevent or limit operation of the heating system under a low aerosol precursor condition.

In some examples, the step of determining whether the detected IR spectrum is indicative of the heating system operating in an absence of liquid aerosol precursor may comprise determining a temperature and/or a rate of increase of temperature and/or a rate of decrease of temperature of the heating system from the detected IR spectrum.

The temperature and/or rate of change of temperature may provide an indication of a low aerosol precursor operating condition, and may thereby be used to prevent or limit operation of the heating system under a low aerosol precursor condition.

In some examples, the step of determining whether the detected IR spectrum is indicative of the heating system operating in an absence of liquid aerosol precursor may comprise determining a presence of generated aerosol from the detected IR spectrum.

Interrupting the operation of the heater based on a lack of detected aerosol may enable the apparatus to prevent or limit operation of the heating system under a low aerosol precursor condition.

The preceding summary is provided for purposes of summarizing some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE FIGURES

Aspects, features and advantages of the present disclosure will become apparent from the following description of examples in reference to the appended drawings in which like numerals denote like elements.

FIG. 1 is a block system diagram showing an example aerosol generating apparatus.

FIG. 2 is a block system diagram showing an example implementation of the apparatus of FIG. 1, where the aerosol generating apparatus is configured to generate aerosol from a liquid precursor.

FIGS. 3a and 3b are schematic diagrams showing an example implementation of the apparatus of FIG. 2.

FIG. 4 is a schematic diagram showing a further example implementation of the apparatus of FIG. 2.

FIG. 5 is an example operating method for the apparatus of FIG. 4.

FIG. 6 is a second example operating method for the apparatus of FIG. 4.

### DETAILED DESCRIPTION OF EMBODIMENTS

Before describing several examples implementing the present disclosure, it is to be understood that the present disclosure is not limited by specific construction details or process steps set forth in the following description and accompanying drawings. Rather, it will be apparent to those skilled in the art having the benefit of the present disclosure that the systems, apparatuses and/or methods described herein could be embodied differently and/or be practiced or carried out in various alternative ways.

Unless otherwise defined herein, scientific and technical terms used in connection with the presently disclosed inventive concept(s) shall have the meanings that are commonly understood by those of ordinary skill in the art, and known techniques and procedures may be performed according to conventional methods well known in the art and as described in various general and more specific references that may be cited and discussed in the present specification.

Any patents, published patent applications, and non-patent publications mentioned in the specification are hereby incorporated by reference in their entirety.

All examples implementing the present disclosure can be made and executed without undue experimentation in light of the present disclosure. While particular examples have been described, it will be apparent to those of skill in the art that variations may be applied to the systems, apparatus, and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context.

The use of the term “or” in the present disclosure (including the claims) is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used in this specification and claim(s), the words “comprising, “having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of example(s), embodiment(s), or dependency of claim(s). Moreover, this also applies to the phrase “in one embodiment,” “according to an embodiment,” and the like, which are merely a stylistic form of wording and are not to be construed as limiting the following features to a separate embodiment to all other instances of the same or similar wording. This is to say, a reference to ‘an,’ ‘one,’ or ‘some’ embodiment(s) may be a reference to any one or more, and/or all embodiments, or combination(s) thereof, disclosed. Also, similarly, the reference to “the” embodiment may not be limited to the immediately preceding embodiment. Further, all references to one or more embodiments or examples are to be construed as non-limiting to the claims.

The present disclosure may be better understood in view of the following explanations, wherein the terms used that are separated by “or” may be used interchangeably:

As used herein, an “aerosol generating apparatus” (or “electronic(e)-cigarette”) may be an apparatus configured to deliver an aerosol to a user for inhalation by the user. The apparatus may additionally/alternatively be referred to as a “smoking substitute apparatus”, if it is intended to be used instead of a conventional combustible smoking article. As used herein a combustible “smoking article” may refer to a cigarette, cigar, pipe or other article, that produces smoke (an aerosol comprising solid particulates and gas) via heating above the thermal decomposition temperature (typically by combustion and/or pyrolysis). An aerosol generated by the apparatus may comprise an aerosol with particle sizes of 0.2-7 microns, or less than 10 microns, or less than 7 microns. This particle size may be achieved by control of one or more of: heater temperature; cooling rate as the vapour condenses to an aerosol; flow properties including turbulence and velocity. The generation of aerosol by the aerosol generating apparatus may be controlled by an input device. The input device may be configured to be user-activated, and may for example include or take the form of an actuator (e.g. actuation button) and/or an airflow sensor.

Each occurrence of the aerosol generating apparatus being caused to generate aerosol for a period of time (which may be variable) may be referred to as an “activation” of the aerosol generating apparatus. The aerosol generating apparatus may be arranged to allow an amount of aerosol delivered to a user to be varied per activation (as opposed to delivering a fixed dose of aerosol), e.g. by activating an aerosol generating unit of the apparatus for a variable amount of time, e.g. based on the strength/duration of a draw of a user through a flow path of the apparatus (to replicate an effect of smoking a conventional combustible smoking article).

The aerosol generating apparatus may be portable. As used herein, the term “portable” may refer to the apparatus being for use when held by a user.

As used herein, an “aerosol generating system” may be a system that includes an aerosol generating apparatus and optionally other circuitry/components associated with the function of the apparatus, e.g. one or more external devices and/or one or more external components (here “external” is intended to mean external to the aerosol generating apparatus). As used herein, an “external device” and “external component” may include one or more of a: a charging device, a mobile device (which may be connected to the aerosol generating apparatus, e.g. via a wireless or wired connection); a networked-based computer (e.g. a remote server); a cloud-based computer; any other server system.

An example aerosol generating system may be a system for managing an aerosol generating apparatus. Such a system may include, for example, a mobile device, a network server, as well as the aerosol generating apparatus.

As used herein, an “aerosol” may include a suspension of precursor, including as one or more of: solid particles; liquid droplets; gas. Said suspension may be in a gas including air. An aerosol herein may generally refer to/include a vapour. An aerosol may include one or more components of the precursor.

As used herein, a “precursor” may include one or more of a: liquid; solid; gel; loose leaf material; other substance. The precursor may be processed by an aerosol generating unit of an aerosol generating apparatus to generate an aerosol. The precursor may include one or more of: an active component; a carrier; a flavouring. The active component may include one or more of nicotine; caffeine; a cannabidiol oil; a non-pharmaceutical formulation, e.g. a formulation which is not for treatment of a disease or physiological malfunction of the human body. The active component may be carried by the carrier, which may be a liquid, including propylene glycol and/or glycerine. The term “flavouring” may refer to a component that provides a taste and/or a smell to the user. The flavouring may include one or more of: Ethylvanillin (vanilla); menthol, Isoamyl acetate (banana oil); or other. The precursor may include a substrate, e.g. reconstituted tobacco to carry one or more of the active component; a carrier; a flavouring.

As used herein, a “storage portion” may be a portion of the apparatus adapted to store the precursor. It may be implemented as fluid-holding reservoir or carrier for solid material depending on the implementation of the precursor as defined above.

As used herein, a “flow path” may refer to a path or enclosed passageway through an aerosol generating apparatus, e.g. for delivery of an aerosol to a user. The flow path may be arranged to receive aerosol from an aerosol generating unit. When referring to the flow path, upstream and downstream may be defined in respect of a direction of flow in the flow path, e.g. with an outlet being downstream of an inlet.

As used herein, a “delivery system” may be a system operative to deliver an aerosol to a user. The delivery system may include a mouthpiece and a flow path.

As used herein, a “flow” may refer to a flow in a flow path. A flow may include aerosol generated from the precursor. The flow may include air, which may be induced into the flow path via a puff by a user.

As used herein, a “puff” (or “inhale” or “draw”) by a user may refer to expansion of lungs and/or oral cavity of a user to create a pressure reduction that induces flow through the flow path.

As used herein, an “aerosol generating unit” may refer to a device configured to generate an aerosol from a precursor. The aerosol generating unit may include a unit to generate a vapour directly from the precursor (e.g. a heating system or other system) or an aerosol directly from the precursor (e.g. an atomiser including an ultrasonic system, a flow expansion system operative to carry droplets of the precursor in the flow without using electrical energy or other system). A plurality of aerosol generating units to generate a plurality of aerosols (for example, from a plurality of different aerosol precursors) may be present in an aerosol generating apparatus.

As used herein, a “heating system” may refer to an arrangement of at least one heating element, which is operable to aerosolise a precursor once heated. The at least one heating element may be electrically resistive to produce heat from the flow of electrical current therethrough. The at least one heating element may be arranged as a susceptor to produce heat when penetrated by an alternating magnetic field. The heating system may be configured to heat a precursor to below 300 or 350 degrees C, including without combustion.

As used herein, a “consumable” may refer to a unit that includes a precursor. The consumable may include an aerosol generating unit, e.g. it may be arranged as a cartomizer. The consumable may include a mouthpiece. The consumable may include an information carrying medium. With liquid or gel implementations of the precursor, e.g. an e-liquid, the consumable may be referred to as a “capsule” or a “pod” or an “e-liquid consumable”. The capsule/pod may include a storage portion, e.g. a reservoir or tank, for storage of the precursor. With solid material implementations of the precursor, e.g. tobacco or reconstituted tobacco formulation, the consumable may be referred to as a “stick” or “package” or “heat-not-burn consumable”. In a heat-not-burn consumable, the mouthpiece may be implemented as a filter and the consumable may be arranged to carry the precursor. The consumable may be implemented as a dosage or pre-portioned amount of material, including a loose-leaf product.

As used herein, an “information carrying medium” may include one or more arrangements for storage of information on any suitable medium. Examples include: a computer readable medium; a Radio Frequency Identification (RFID) transponder; codes encoding information, such as optical (e.g. a bar code or QR code) or mechanically read codes (e.g. a configuration of the absence or presents of cut-outs to encode a bit, through which pins or a reader may be inserted).

As used herein “heat-not-burn” (or “HNB” or “heated precursor”) may refer to the heating of a precursor, typically tobacco, without combustion, or without substantial combustion (i.e. localised combustion may be experienced of limited portions of the precursor, including of less than 5% of the total volume).

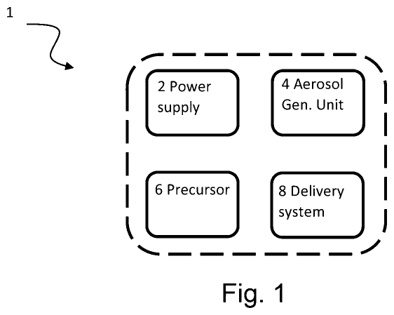

Referring to FIG. 1, an example aerosol generating apparatus 1 includes a power supply 2, for supply of electrical energy. The apparatus 1 includes an aerosol generating unit 4 that is driven by the power supply 2. The power supply 2 may include an electric power supply in the form of a battery and/or an electrical connection to an external power source. The apparatus 1 includes a precursor 6, which in use is aerosolised by the aerosol generating unit 4 to generate an aerosol. The apparatus 2 includes a delivery system 8 for delivery of the aerosol to a user.

Electrical circuitry (not shown in FIG. 1) may be implemented to control the interoperability of the power supply 4 and aerosol generating unit 6.

In variant examples, which are not illustrated, the power supply 2 may be omitted since, e.g. an aerosol generating unit implemented as an atomiser with flow expansion may not require a power supply.

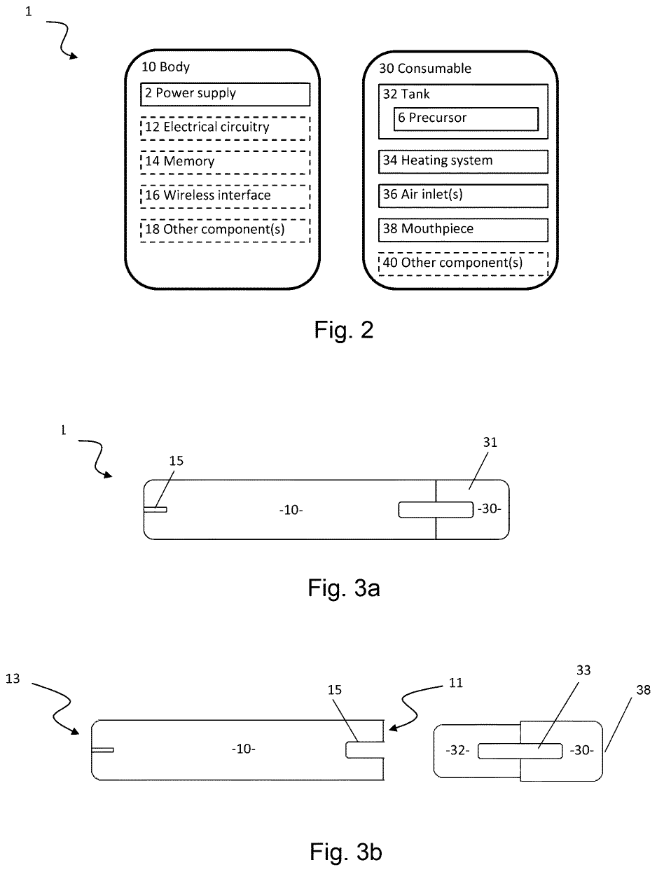

FIG. 2 shows an implementation of the apparatus 1 of FIG. 1, where the aerosol generating apparatus 1 is configured to generate aerosol from a liquid precursor.

In this example, the apparatus 1 includes a device body 10 and a consumable 30.

In this example, the body 10 includes the power supply 4. The body may additionally include any one or more of electrical circuitry 12, a memory 14, a wireless interface 16, one or more other components 18.

The electrical circuitry 12 may include a processing resource for controlling one or more operations of the body 10 and consumable 30, e.g. based on instructions stored in the memory 14.

The wireless interface 16 may be configured to communicate wirelessly with an external (e.g. mobile) device, e.g. via Bluetooth.

The other component(s) 18 may include one or more user interface devices configured to convey information to a user and/or a charging port, for example (see e.g. FIG. 3).

The consumable 30 includes a storage portion implemented here as a tank 32 which stores the liquid precursor 6 (e.g. e-liquid). The consumable 30 also includes a heating system 34, one or more air inlets 36, and a mouthpiece 38. The consumable 30 may include one or more other components 40.

The body 10 and consumable 30 may each include a respective electrical interface (not shown) to provide an electrical connection between one or more components of the body 10 with one or more components of the consumable 30. In this way, electrical power can be supplied to components (e.g. the heating system 34) of the consumable 30, without the consumable 30 needing to have its own power supply.

In use, a user may activate the aerosol generating apparatus 1 when inhaling through the mouthpiece 38, i.e. when performing a puff. The puff, performed by the user, may initiate a flow through a flow path in the consumable 30 which extends from the air inlet(s) 34 to the mouthpiece 38 via a region in proximity to the heating system 34.

Activation of the aerosol generating apparatus 1 may be initiated, for example, by an airflow sensor in the body 10 which detects airflow in the aerosol generating apparatus 1 (e.g. caused by a user inhaling through the mouthpiece), or by actuation of an actuator included in the body 10. Upon activation, the electrical circuitry 12 (e.g. under control of the processing resource) may supply electrical energy from the power supply 2 to the heating system 34 which may cause the heating system 32 to heat liquid precursor 6 drawn from the tank to produce an aerosol which is carried by the flow out of the mouthpiece 38.

In some examples, the heating system 34 may include a heating filament and a wick, wherein a first portion of the wick extends into the tank 32 in order to draw liquid precursor 6 out from the tank 32, wherein the heating filament coils around a second portion of the wick located outside the tank 32.

The heating filament may be configured to heat up liquid precursor 6 drawn out of the tank 32 by the wick to produce the aerosol.

In this example, the aerosol generating unit 4 is provided by the above-described heating system 34 and the delivery system 8 is provided by the above-described flow path and mouthpiece 38.

In variant embodiments (not shown), any one or more of the precursor 6, heating system 34, air inlet(s) 36 and mouthpiece 38, may be included in the body 10. For example, the mouthpiece 36 may be included in the body 10 with the precursor 6 and heating system 32 arranged as a separable cartomizer.

FIGS. 3a and 3b show an example implementation of the aerosol generating device 1 of FIG. 2. In this example, the consumable 30 is implemented as a capsule/pod, which is shown in FIG. 3a as being physically coupled to the body 10, and is shown in FIG. 3b as being decoupled from the body 10.

In this example, the body 10 and the consumable 30 are configured to be physically coupled together by pushing the consumable 30 into an aperture in a top end 11 the body 10, with the consumable 30 being retained in the aperture via an interference fit.

In other examples (not shown), the body 10 and the consumable 30 could be physically coupled together in other ways, e.g. by screwing one onto the other, through a bayonet fitting, or through a snap engagement mechanism, for example.

The body 10 also includes a charging port (not shown) at a bottom end 13 of the body 10.

The body 10 also includes a user interface device configured to convey information to a user. Here, the user interface device is implemented as a light 15, which may e.g. be configured to illuminate when the apparatus 1 is activated. Other user interface devices are possible, e.g. to convey information haptically or audibly to a user.

In this example, the consumable 30 has an opaque cap 31, a translucent tank 32 and a translucent window 33. When the consumable 30 is physically coupled to the body 10 as shown in FIG. 3a, only the cap 31 and window 33 can be seen, with the tank 32 being obscured from view by the body 10. The body 10 includes a slot 15 to accommodate the window 33. The window 33 is configured to allow the amount of liquid precursor 6 in the tank 32 to be visually assessed, even when the consumable 30 is physically coupled to the body 10.

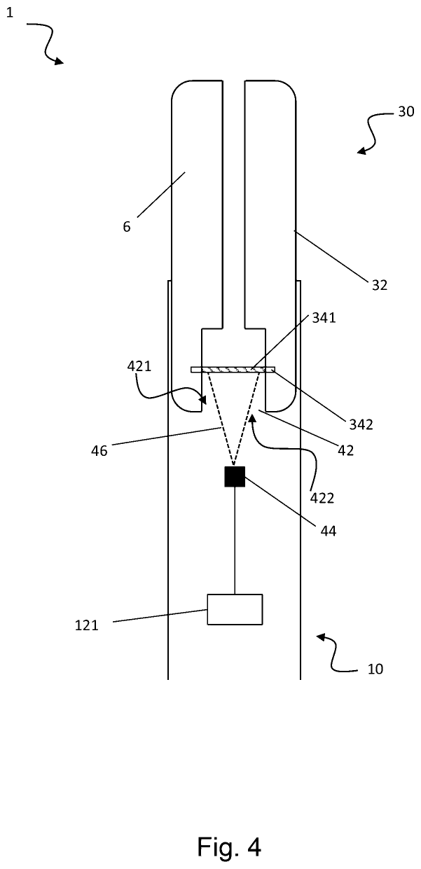

Referring to FIG. 4, an aerosol generating apparatus 1, which may be implemented in any of the preceding examples, comprises a body 10 and a consumable 30. The consumable 30 includes a heating system 34 including a heater 341. In the illustrated example, the heating system 34 further includes a wick 342, with the heater 341 being formed on a surface of the wick 342. Alternative configurations are possible for the heater 341 and for the wick 342. The wick 342 may be omitted in some examples.

Where present, the wick 342 extends into the tank 32 to convey aerosol precursor 6 from the tank 32 to the heater 341, thereby allowing the heater 341 to generate an aerosol or a vapour from the aerosol precursor 6.

The consumable 30 further comprises an infrared (IR) transmissive window 42 through which IR radiation can radiate from the heating system 34 to be emitted from the consumable 30. In other words, the IR transmissive window 42 is at least partially transmissive to IR radiation, and may be formed of a material that is at least partially transmissive to IR radiation. For example, the IR transmissive window 42 may be at least 25% transmissive to IR radiation, such that 25% of incident IR radiation may pass through the window. The IR transmissive window 42 may be at least 50% transmissive to IR radiation, such that 50% of incident IR radiation may pass through the window. The IR transmissive window 42 may be at least 75% transmissive to IR radiation, such that 75% of incident IR radiation may pass through the window. The IR transmissive window 42 may be at least 90% transmissive to IR radiation, such that 90% of incident IR radiation may pass through the window.

The IR transmissive window 42 may be configured to selectively filter one or more wavelengths (i.e. to reduce or restrict the passage of certain wavelengths of IR or other radiation through the IR transmissive window 42). For example, the IR transmissive window 42 may be configured to filter visible light to reduce the transmission of ambient light through the IR transmissive window 42 to the sensor 44. Additionally or alternatively, the IR transmissive window 42 may be configured to filter particular IR wavelengths to reduce or avoid saturation of the sensor 44 when the heating system 34 is operated.

In the illustrated example, the IR transmissive window 42 forms part of an outer surface of the consumable 30, and is arranged flush with a base end surface of the consumable 30. In other examples, the IR transmissive window 42 may be arranged in a recess of the base end surface of the consumable. The IR transmissive window 42 may also be arranged in a side surface of the consumable 30 in addition to or as an alternative to being arranged in the base end surface of the consumable 30. The IR transmissive window 42 may be a fluid and/or air tight opening to maintain a seal of the consumable 30. In other words, the IR transmissive window 42 may be formed of such a material and mounted in such a way in the consumable 30 that the IR transmissive window 42 is sealed (e.g. hermetically sealed) and does not form a port or opening for enabling fluid or air egress or ingress to the consumable 30.

The IR transmissive window 42 may be planar, or may have a non-planar upper or inward (i.e. facing in to the consumable 30) surface 421 and/or a non-planar lower or outward (i.e. facing away from the consumable 30) surface 422. In some examples, the inward surface 421 may be shaped (e.g. convex) to displace liquid (e.g. aerosol precursor) that impinges on the surface 421. In other examples, the IR transmissive window 42 may additionally or alternatively be formed as a lens to focus IR radiation passing through the IR transmissive window 42, such as IR radiation emitting from the heating system 42 and passing outwardly of the consumable 30. In some examples, the lens may be configured such that a focal point of the lens lies on a surface of the heater 341.

The body 10 comprises a sensor 44 for detecting IR radiation. The sensor 44 may be operable to detect radiation at one or more wavelengths within the IR electromagnetic spectrum. In some examples, the sensor 44 may be operable to detect a plurality of wavelengths forming a spectrum of IR radiation.

An optical path 46 is formed between the heating system 34 and the sensor 44 that passes through the IR transmissive window 42. In other words, there is a path along which IR radiation emitted from the heating system 34 may pass through the IR transmissive window 42 to the sensor 44. In the illustrated example, the optical path 46 is a straight path between the heating system 34 and the sensor 44. In other examples, one or more optical elements such as mirrors or lenses may be arranged along the optical path 46 to direct the IR radiation along the optical path 46.

The body 10 may further comprise electrical circuitry 12 such as a control unit 121. The control unit 121 may be operable to receive an input from the IR sensor 44.

The control unit 121 may be operable to perform processing of the input from the IR sensor 44 to detect or determine a temperature or a rate of change of temperature of the heating system 34. In some examples, the IR sensor 44 may comprise integrated circuitry such that the IR sensor 44 is operable to output a detected temperature to the control unit 121.

The control unit 121 may further be operable to control an operation of the heating system 34 based on a received input from the IR sensor 44. In some examples, the control unit 121 may be operable to control the heating system 34 to operate, and may be operable to interrupt or cease operation of the heating system based on a received input from the IR sensor 44.

For example, the control unit 121 may be operable to interrupt operation of the heating system 34 based on a detected temperature (e.g. a peak temperature) being higher than a temperature threshold value. The control unit 121 may be operable to interrupt operation of the heating system 34 based on a detected temperature increase rate (e.g. heating rate) being higher than a temperature increase rate threshold value (i.e. more rapid heating than a threshold rate). The control unit 121 may be operable to interrupt operation of the heating system 34 based on a detected temperature decrease rate or cooling rate (e.g. following a heating cycle of the heating system 34) being lower than a temperature decrease rate threshold value (i.e. slower cooling than a threshold rate).

Additionally or alternatively, the control unit 121 may be operable to perform a determination based on an IR spectrum detected by the IR sensor 44. For example, the control unit 121 may be operable to determine that the detected IR spectrum is indicative of an absence of aerosol precursor 6 being supplied to the heating system 34 or that the heating system 34 is operating in an absence of aerosol precursor 6. Particular wavelengths of the spectrum may be present at different intensities in the presence or absence of aerosol precursor 6 supplied to the heating system 34, enabling the operating condition of the heating system 34 to be determined or derived from the detected spectrum. The detected spectrum may also enable the detection of aerosol or vapour generated by the heating system 34. For example, particular wavelengths of the spectrum may be present at different intensities in the presence or absence of aerosol (for example due to absorption and/or scattering of IR radiation by the aerosol). In this way, the control unit 121 may be operable to determine the presence or absence of aerosol generated by the heating system 34 as an indicator of the presence or absence of aerosol precursor 6 supplied to the heating system 34.

The control unit 121 may be operable to interrupt operation of the heating system 34 when a detected spectrum is indicative of the heating system 34 operating in an absence of aerosol precursor 6. The control unit 121 may be operable to interrupt operation of the heating system when a detected spectrum is indicative of the heating system 34 operating without producing an aerosol or vapour. In this way, operation of the heating system in an absence of aerosol precursor 6, or without producing an aerosol or vapour may be reduced or prevented.

Where the control unit 121 interrupts or ceases operation of the heating unit 34, this may involve preventing operation of the heating unit 34 for a predetermined period or lock out period. In other examples, a reset operation may be required from a user before operation of the heating unit 34 can be restarted. In still further examples, operation of the heating unit 34 may be ceased until the consumable 30 has been replaced with another consumable 30. The device 1 or the main body 10 may further provide information to the user via a user interface device to indicate that an interruption has occurred.

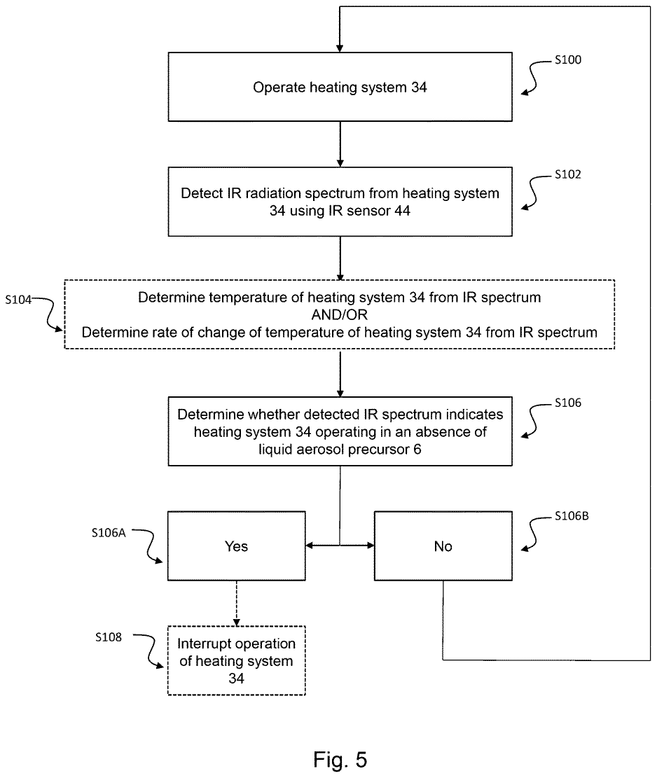

FIG. 5 illustrates an example operating sequence or operating method which may be implemented in any of the preceding examples. The heating system 34 is operated (step S100), and the IR radiation spectrum from the heating system 34 is detected via the IR sensor 44 (step S102). The control unit 121 determines whether the detected IR spectrum indicates that the heating system 34 is operating in an absence of aerosol precursor 6 (step S106). Optionally, when it is determined that the detected IR spectrum indicates that the heating system 34 is operating in an absence of aerosol precursor 6 (step S106A), the control unit 121 interrupts operation of the heating system 34. When it is not determined that the detected IR spectrum indicates that the heating system 34 is operating in an absence of aerosol precursor 6 (step S106B), the control unit 121 continues operation of the heating system 34.

In this example, the control unit 121 may optionally determine a temperature of the heating system 34 from the detected IR spectrum or may optionally determine a rate of change (i.e. rate of increase or decrease) of temperature of the heating system 34 from the detected IR spectrum (step S104). The outcome or result of this determination may be used to determine whether the detected IR spectrum indicates that the heating system 34 is operating in an absence of aerosol precursor 6.

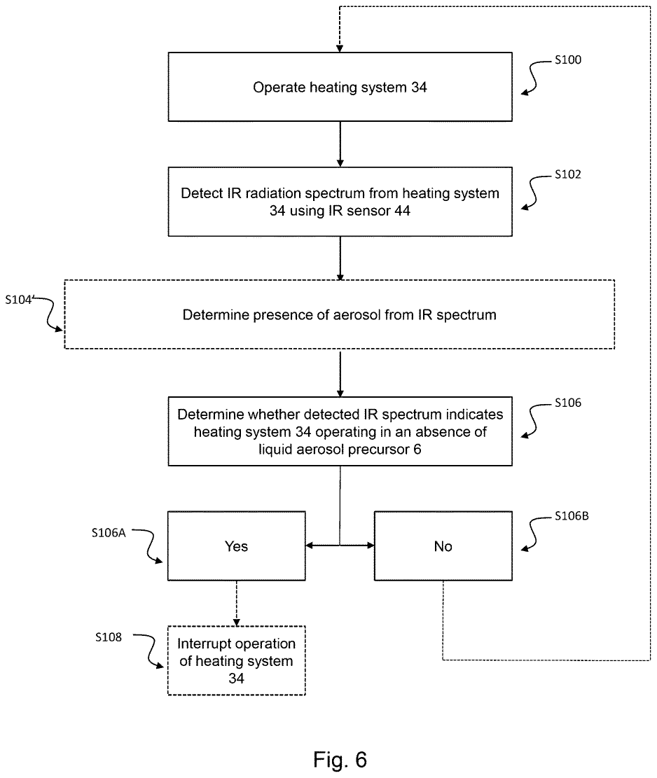

FIG. 6 illustrates a further example operating sequence or operating method which may be implemented in any of the preceding examples. Steps that are identical to those of FIG. 5 are indicated with the same reference numerals. The difference between the method of FIG. 5 and the method of FIG. 6 is that in optional step S104′, it is the presence of aerosol that is determined from the IR spectrum.

1. An aerosol generating apparatus comprising a device body and a consumable, wherein:
the device body comprises a sensor for detecting infrared, IR, radiation;
the consumable comprises a heating system operable to generate an aerosol from a liquid aerosol precursor, the heating system including a heater;
wherein an optical path is formed between the heating system and the sensor; and wherein the consumable comprises an IR transmissive window located along the optical path and through which IR radiation can radiate from the heating system to the sensor.

2. An aerosol generating apparatus according to claim 1, wherein the IR transmissive window is at least one of an impermeable, sealed, hermetically sealed, fluid-tight or air-tight IR transmission opening, and/or wherein the IR transmissive window comprises a transparent material or IR transparent material.

3. An aerosol generating apparatus according to any preceding claim, wherein the IR transmissive window comprises a lens for focussing IR radiation from the heating system on to the sensor.

4. An aerosol generating apparatus according to any preceding claim, wherein a surface of the window facing towards the heating system is shaped to displace a liquid aerosol precursor incident on the surface of the window from the optical path.

5. An aerosol generating apparatus according to any preceding claim, wherein the window comprises an optical filter.

6. An aerosol generating apparatus according to any preceding claim, wherein the IR sensor is configured to detect an IR spectrum of the heating system.

7. An aerosol generating apparatus according to claim 6, wherein the apparatus is configured to determine a temperature and/or a rate of increase of temperature and/or a rate of decrease of temperature of the heating system based on the detected IR spectrum.

8. An aerosol generating apparatus according to claim 7, further comprising control means for controlling operation of the heater, wherein the control means is operable to interrupt operation of the heater when the determined temperature of the heating system rises above a threshold value and/or when the rate of increase of temperature is higher than a temperature increase rate threshold value and/or when the rate of decrease of temperature is lower than a temperature decrease rate threshold value.

9. An aerosol generating apparatus according to any of claims 6 to 8, further comprising control means for controlling operation of the heater, wherein the control means is operable to interrupt operation of the heater when the detected IR spectrum of the heating system is indicative of the heating system operating in an absence of liquid aerosol precursor.

10. An aerosol generating apparatus according to any of claims 6 to 9, wherein the apparatus is configured to determine a presence of the aerosol generated by the heating system from the liquid aerosol precursor based on the detected IR spectrum.

11. An aerosol generating apparatus according to claim 10, further comprising control means for controlling operation of the heater, wherein the control means is operable to interrupt operation of the heater when the heater is heated and when the detected IR spectrum indicative of the absence of the aerosol generated by the heating system.

12. A method of operating an aerosol generating apparatus according to any preceding claim, the method comprising the steps of:
operating the heating system;
detecting IR radiation from the heating system using the IR sensor to generate a detected IR spectrum;
determining whether the detected IR spectrum is indicative of the heating system operating in an absence of liquid aerosol precursor.

13. A method of operating an aerosol generating apparatus according to claim 12, further comprising a step of interrupting operation of the heating system when it is determined that the detected IR spectrum is indicative of the heating system operating in an absence of liquid aerosol precursor.

14. A method according to claim 12 or claim 13, wherein the step of determining whether the detected IR spectrum is indicative of the heating system operating in an absence of liquid aerosol precursor comprises determining a temperature and/or a rate of increase of temperature and/or a rate of decrease of temperature of the heating system from the detected IR spectrum.

15. A method according to any of claims 12 to 14, wherein the step of determining whether the detected IR spectrum is indicative of the heating system operating in an absence of liquid aerosol precursor comprises determining a presence of generated aerosol from the detected IR spectrum.
